(19) United States
(12) Patent Application Publication
(10) Pub. No.: US 2008/0292028 A1
(43) Pub. Date: Nov. 27, 2008

(54) Method and Apparatus for Signal Processing and Encoding and Decoding Method, and Apparatus Therefor

(75) Inventor: Hyen-O Oh, Gyeonggi-do (KR)

Correspondence Address: FISH & RICHARDSON P.C., PO BOX 1022, MINNEAPOLIS, MN, 55440-1022, US

(73) Assignee: LG ELECTRONICS, INC., Seoul (KR)

(21) Appl. No.: 12/091,930

(22) PCT Filed: Oct. 31, 2006
(86) PCT No.: PCT/KR2006/004493

§ 371 Date: Apr. 28, 2008

Related U.S. Application Data
(60) Provisional application No. 60/731,244, filed on Oct. 31, 2005.

(51) Int. Cl. H04L 27/06

(52) U.S. Cl. 375/340

(57) ABSTRACT

There are disclosed a signal processing method and apparatus according to the present invention. The method includes the steps of acquiring pattern information corresponding to a pattern formed by a plurality of data, and pattern residual information generated in response to the pattern information, and acquiring the data based on the pattern information and the pattern residual information. Accordingly, efficient data coding is possible.

### TECHNICAL FIELD

The present invention relates to a signal processing method and apparatus. More particularly, the present invention relates to a coding method for the compression of a signal and the restoration of a signal, and an apparatus therefor.

### BACKGROUND ART

Lots of techniques concerned with signal compression and restoration have been introduced so far. In general, a target object of corresponding techniques is data including audio and video. Further, signal compression or restoration techniques have been developed in a direction to improve the picture quality or the sound quality while increasing the compression ratio. Furthermore, there has been an effect to improve transmission efficiency in order to adapt to a variety of communication environments.

However, it has generally been said that there is room for effective improvement in transmission efficiency. Accordingly, there is a need for a detailed research capable of maximizing transmission efficiency of a signal even under a complex communication environment by developing a new processing solution for the signal.

### DISCLOSURE OF INVENTION

### Technical Problem

Accordingly, the present invention has been made keeping in mind the above problems occurring in the prior art, and an object of the present invention is to provide a signal processing method and apparatus, in which transmission efficiency of a signal can be optimized. Another object of the present invention is to provide an efficient data coding method and an apparatus therefor.

### Technical Solution

To accomplish the above objects of the present invention, a signal processing method of the present invention includes the steps of acquiring pattern information corresponding to a pattern formed by a plurality of data, and pattern residual information generated in response to the pattern information, and acquiring the data based on the pattern information and the pattern residual information.

To accomplish the above objects of the present invention, another signal processing method of the present invention includes the steps of generating pattern information corresponding to a pattern formed by a plurality of data, and pattern residual information corresponding to the pattern information, and outputting the pattern information and the pattern residual information.

To accomplish the above objects of the present invention, a signal processing apparatus of the present invention includes an information acquisition part for acquiring pattern information corresponding to a pattern formed by a plurality of data, and pattern residual information generated in response to the pattern information, and a data acquisition part for acquiring the data based on the pattern information and the pattern residual information.

To accomplish the above objects of the present invention, still another signal processing method of the present invention includes the steps of acquiring identification information indicating a data coding method, pattern information corresponding to a pattern formed by a plurality of data, and pattern residual information corresponding to the pattern information, and acquiring the data based on the pattern information and the pattern residual information in accordance with the data coding method based on the identification information.

To accomplish the above objects of the present invention, another signal processing apparatus of the present invention includes an information acquisition part for acquiring identification information indicating a data coding method, pattern information corresponding to a pattern formed by a plurality of data, and pattern residual information corresponding to the pattern information, and a data acquisition part for acquiring the data based on the pattern information and the pattern residual information in accordance with the data coding method based on the identification information.

To accomplish the above objects of the present invention, still another signal processing method of the present invention includes the steps of generating identification information indicating a data coding method decided according to a pre-determined condition, pattern information corresponding to a pattern formed by a plurality of data, and pattern residual information corresponding to the pattern information, and outputting the identification information, the pattern information, and the pattern residual information.

To accomplish the above objects of the present invention, still another signal processing apparatus of the present invention includes an information generating part for generating identification information indicating a data coding method decided according to a predetermined condition, pattern information corresponding to a pattern formed by a plurality of data, and pattern residual information corresponding to the pattern information, and an information output part for outputting the identification information, the pattern information, and the pattern residual information.

### ADVANTAGEOUS EFFECTS

Efficient data coding is made possible through a signal processing method and apparatus according to the present invention. Through this, data compression and restoration with high transmission efficiency are made possible. Incidentally, lossless coding is possible using a bit number smaller than that required when coding an original signal. In particular, pattern residual information can experience loss coding for higher compression efficiency by means of template-based coding. In addition, there is an advantage in that compression efficiency can be enhanced while not increasing the computational amount so much.

### BRIEF DESCRIPTION OF THE DRAWINGS

FIGS. 1 and 2 illustrate a system according to the present invention;

FIGS. 3 to 5 are exemplary views for helping the understanding of template-based coding;

FIG. 6 is a block diagram of a data encoding part for compressing a signal based on template-based coding according to an embodiment of the present invention;

FIG. 7 is a block diagram of a first or second decoding part for restoring a compressed signal based on template-based coding according to an embodiment of the present invention; and

FIG. 8 is a block diagram of a signal processing apparatus for audio compression and restoration according to an embodiment of the present invention.

### BEST MODE FOR CARRYING OUT THE INVENTION

Hereinafter, constructions and operations of the present invention will be described in connection with embodiments with reference to the accompanying drawings. The constructions and operations of the present invention, which are shown in the drawings and described with reference to the drawings, are described in connection with at least one embodiment, and are not intended to limit the technical spirit of the present invention, and a core construction and operation thereof.

Furthermore, general terms that have been widely used in the field have been selected as terms used in the present invention. In a special case, terms arbitrarily selected by the applicant will be used. In this case, the meanings of the terms will be clearly defined in detailed description of corresponding parts. Thus, it should not be allowed that terms be simply interpreted only by the names of terms used in the description of the present invention, but be interpreted after understanding the meanings of corresponding terms.

In relation to the issue, the meaning of the term “coding” used in the present invention includes an encoding process and a decoding process. However, it is evident that a specific coding process can be applied to any one of the encoding process and the decoding process, which will be described in a corresponding description part.

[Overall Introduction of the Present Invention]

In general, a method of coding a signal can be classified into data coding and entropy coding. In this case, data coding and entropy coding may have correlation. Furthermore, a detailed example in which data coding according to the present invention is applied will be described by taking a method of coding audio having spatial information (for example, “ISO/IEC 23003, MPEG Surround”) as an example.

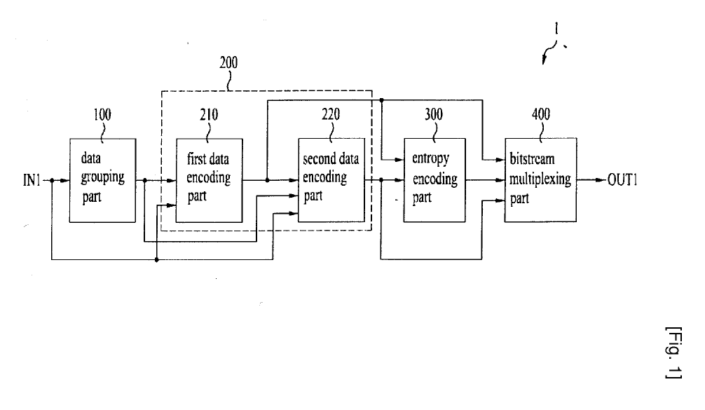

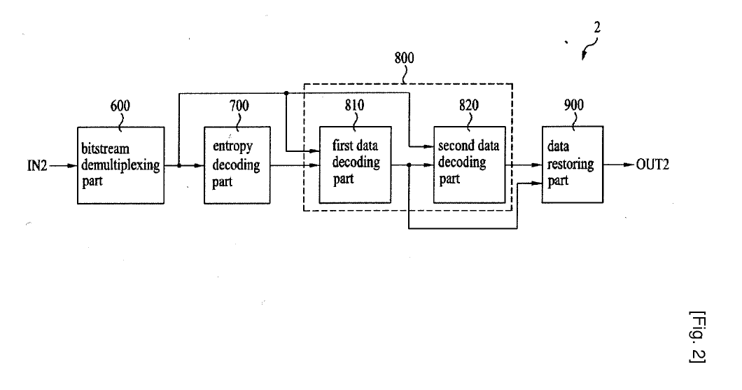

FIGS. 1 and 2 illustrate a system according to the present invention. FIG. 1 illustrates an encoding apparatus 1, and FIG. 2 illustrates a decoding apparatus 2.

The encoding apparatus 1 shown in FIG. 1 includes at least one of a data grouping part 100, a data encoder 200, an entropy encoding part 300, and a bitstream multiplexing part 400. In this case, it is evident that in the case where the data grouping part 100 and/or the entropy encoding part 300 are/is not used in a specific system employing the present invention, the encoding apparatus 1 can be constructed except for the data grouping part 100 and/or the entropy encoding part 300.

The data grouping part 100 binds data received through an input terminal IN1 on a unit basis in order to improve data processing efficiency. According to the present invention, the data grouping part 100 can be built in the data encoder 200 depending on a data coding method, unlike FIG. 1. For example, the data grouping part 100 may be included in at least one of the first and second data encoding parts 210 and 220. Furthermore, the data grouping part 100 can divide some of data into one or more groups for efficiency of data processing. Each of the divided group-based data can be encoded in the data encoder 200. Hereinafter, the last group to which a specific grouping method has been applied through the data grouping part 100 is referred to as a “data group”, and a group, which is a subject to interest for current coding, of the data groups is referred to as an “object group”. At this time, data that is grouped and has a specific meaning can become a “parameter” used to restore an audio signal.

The data grouping part 100 can group data in various ways. For example, the data grouping method may include an interleave method, a vector method or a matrix method.

An embodiment of a method of grouping a plurality of data using the data grouping part 100 is described below. The data grouping part 100 interleaves and groups a plurality of data. For example, it is assumed that the plurality of data include 7, 6, 2, 8, 9, 10, 11, 16, 5, 4 . . . and so on. At this time, every two data are interleaved, 7, 8, 11, 4 . . . are grouped, 6, 9, 16, . . . are grouped, and 2, 10, 5, . . . are grouped. Furthermore, the plurality of data can be grouped in a matrix in which the number of rows or columns is 1, that is, a matrix whose dimension is 1×a or a×1. For example, when the length “a” of a matrix is 5, the data can be grouped like [7 6 2 8 9] and [10 11 16 5 4]. Furthermore, the plurality of data can be grouped in a matrix form as in Math Figure 1.

$$[ \begin{matrix}7 & 6 & 2 & 8 & 9 \\ 10 & 11 & 16 & 5 & 4\end{matrix} ] \qquad MathFigure 1$$

The data encoder 200 shown in FIG. 1 can be implemented in various forms. For example, the data encoder 200 may include the first data encoding part 210 and the second data encoding part 220 arranged in series, as illustrated in FIG. 1. Alternatively, the data encoder 200 may include only at least one of the first and second data encoding parts 210 and 220, or include the first and second data encoding parts 210 and 220 arranged in parallel, unlike FIG. 1. In addition, the data encoder 200 may include three or more data encoding parts. For example, data encoded by the data encoder 200 can undergo variable length coding through the entropy encoding part 300.

The data encoder 200 codes data according to a corresponding encoding method. For example, the data encoder 200 can code data using a pattern-based coding method.

The first data encoding part 210 can code data using the pattern-based coding method, and the second data encoding part 220 can code data by performing at least one of several encoding methods including the pattern-based coding method. An encoding method performed by the second data encoding part 220 may include several encoding methods, such as a conventional video and audio coding method.

The first data encoding part 210 can code data grouped in the data grouping part 100, or can code data that has been received through the input terminal IN1 and has not been grouped. In a similar way, the second data encoding part 220 can code data coded in the first data encoding part 210, code data that has been received through the input terminal IN1 and has not been grouped, or code data grouped in the data grouping part 100.

The entropy encoding part 300 can perform variable length coding according to a statistical characteristic of data with reference to an entropy table (not shown). In general, the entropy encoding part 300 processes the occurrence probability of a specific data in a statistical manner. For example, the entropy encoding part 300 performs a function of increasing transmission efficiency over all by allocating less bits to data having a stochastically high frequency and many bits to data having a stochastically low frequency.

Furthermore, the bitstream multiplexing part 400 can arrange and/or transform data, coded in the first or second data encoding part 210 or 220 or the entropy encoding part 300, according to a transmission rule, and can transmit the resulting data through an output terminal OUT1 in a bitstream format. In the case where the bitstream multiplexing part 400 is not used in a specific system employing the present invention, however, it is evident that a system can be constructed without using the bitstream multiplexing part 400.

The decoding apparatus 2 shown in FIG. 2 includes at least one of a bitstream demultiplexing part 600, an entropy decoding part 700, a data decoder 800 and a data restoring part 900. The bitstream demultiplexing part 600 receives an input bitstream through an input terminal IN2, and interprets and classifies various pieces of information included in the received bitstream according to a predetermined format. The entropy decoding part 700 restores data to data anterior to entropy encoding using an entropy table (not shown). In relation to this issue, it is evident that the entropy table comprises the same table as the entropy table within the encoding apparatus 1.

The data decoder 800 comprises a first data decoding part 810 and a second data decoding part 820. In this case, in the case where the data grouping part 100 and/or the entropy encoding part 300 are/is not used in the encoding apparatus 1 shown in FIG. 1, it is evident that the decoding apparatus 2 can be constructed without using the entropy decoding part 700 and/or the data restoring part 900. That is, the decoding apparatus 2 is constructed in response to the encoding apparatus 1.

Furthermore, the first data decoding part 810 and the second data decoding part 820 perform the decoding processes corresponding to the second data encoding part 220 and the first data encoding part 210, respectively. Further, the data decoder 800 has a construction corresponding to the construction of the data encoder 200 shown in FIG. 1. In other words, when the data encoder 200 includes one of the first and second data encoding parts 210 and 220, the data decoder 800 can include one of the second and first data decoding parts 820 and 810. Further, when the data encoder 200 includes the first and second data encoding parts 210 and 220 constructed in parallel, the data decoder 800 can include the first and second data decoding parts 810 and 820 constructed in parallel.

Furthermore, the data restoring part 900 restores data decoded through the first and second data decoding parts 810 and 820.

The present invention can mix and use two or more coding methods in order to efficiently perform data coding, and can provide an efficient coding method by employing the relation between the coding methods. Further, the present invention can group data in various ways in order to efficiently perform data coding.

In relation to the issue, it is evident that a variety of additional constructions as well as the constituent elements shown in FIGS. 1 and 2 are necessary when the present invention is applied to various systems by using the technical spirit of the present invention. For example, it may be necessary to perform quantization of data or control the above process through a controller (not shown).

An embodiment of a pattern-based coding method of generating pattern residual information by employing pattern information of data according to the present invention is described below.

The pattern-based coding method is a method of coding data based on a pattern formed by a plurality of data. In this method, pattern information and pattern residual information are generated as a result of coding by coding a plurality of data in a method suitable for its pattern. The pattern information refers to information corresponding to a pattern formed by a plurality of data, and may be, for example, the pattern itself or identification information for identifying the pattern, such as an index. Further, the pattern residual information refers to information about coding error of a plurality of data, and indicates error information or differential information between the pattern information and the plurality of data.

The pattern residual information refers to a factor for identifying a pattern when applying template-based coding. As described above, the pattern information can have a one-dimensional form having only values, becoming a basis, or can have a two-dimension form having an index and a gain, depending on a pattern formed by data, which becomes a subject of pattern-based coding.

The pattern information can be calculated according to a pattern of data to be coded, or can be previously set as a template regardless of data to be coded.

How a plurality of data, becoming a subject of pattern-based coding, will be grouped in the data grouping part 100 may be varied depending on a pattern formed by the data. For example, a plurality of data showing a pattern with less distribution can be grouped, or a data set showing a pattern matching a template pattern can be grouped. Incidentally, in the case where the first data encoding part 210 shown in FIG. 1 performs coding using the pattern-based coding method, the data grouping part 100 can group data on a pattern basis, which is formed by a plurality of data, and data included in the group can be encoded by the first data encoding part 210.

A signal processing method of the present invention includes acquiring pattern information corresponding to a pattern formed by a plurality of data, and pattern residual information corresponding to the pattern information, and acquiring data based on the pattern information and the pattern residual information. The signal processing method may further include a process of decoding at least one of the pattern information and the pattern residual information.

Further, a signal processing apparatus of the present invention includes an information acquisition part for acquiring pattern information corresponding to a pattern formed by a plurality of data and pattern residual information generated in response to the pattern information, and a data acquisition part for acquiring data based on the pattern information and the pattern residual information. The information acquisition part and the data acquisition part may be included in the data decoder 800. The signal processing apparatus may further include a residual decoder for decoding pattern residual information.

Another signal processing method according to the present invention includes a process of generating pattern information corresponding to a pattern formed by a plurality of data and pattern residual information corresponding to the pattern information, and outputting the generated pattern information and the generated pattern residual information.

Furthermore, another signal processing apparatus according to the present invention includes an information generating part for generating pattern information corresponding to a pattern formed by a plurality of data and pattern residual information corresponding to the pattern information, and an information output part for outputting the pattern information and the pattern residual information. The information generating part and the information output part are included in the data encoder 200.

A still another signal processing method according to the present invention includes a process of acquiring identification information indicating a data coding method, pattern information, and pattern residual information, and acquiring data based on the pattern information and the pattern residual information in accordance with the data coding method based on the identification information. In this case, the data coding method may be decided depending on the number of a plurality of data, becoming an object of coding. Alternatively, the data coding method may be decided depending on a pattern formed by a plurality of data, becoming an object of coding.

A still another signal processing apparatus according to the present invention includes an information acquisition part for acquiring identification information indicating a data coding method, pattern information, and pattern residual information, and a data acquisition part for acquiring data based on the pattern information and the pattern residual information in accordance with the data coding method based on the identification information. In this case, the information acquisition part and the data acquisition part are included in the data decoder 800.

A still another signal processing method according to the present invention includes a process of generating identification information indicating a data coding method decided according to a predetermined condition, pattern information, and pattern residual information, and outputting the identification information, the pattern information, and the pattern residual information. In this case, the predetermined condition may be the number of a plurality of data, or a pattern formed by a plurality of data.

A still another signal processing apparatus according to the present invention includes an information generating part for generating identification information indicating a data coding method decided according to a predetermined condition, pattern information, and pattern residual information, and an information output part for outputting the identification information, the pattern information, and the pattern residual information. In this case, the information acquisition part and the data acquisition part are included in the data encoder 200.

The pattern-based coding method of the present invention can have low transmission efficiency compared with other coding methods in terms of the fact that additional pattern information has to be selected and be included on a bitstream. Accordingly, it is preferred that the pattern-based coding method be used only when coding efficiency when data is coded by the pattern-based coding method is higher than that when the pattern-based coding method is not used. Whether to use the pattern-based coding method can be determined on a group basis or on groups basis. In this case, a flag notifying whether the pattern-based coding method has been used can be transmitted from the encoding apparatus 1 to the decoding apparatus 2.

The signal processing method of the present invention first includes acquiring pattern information corresponding to a pattern formed by a plurality of data and pattern residual information corresponding to the pattern information, and then acquiring data based on the pattern information and the pattern residual information. The signal processing method may further include a process of decoding at least one of the pattern information and the pattern residual information. Further, data, which is a subject to which the pattern-based coding method will be applied, is a parameter, and the signal processing method may further include a process of restoring an audio signal based on an acquired parameter.

An embodiment of a method of coding a plurality of data using a template, that is, pattern information is described below.

The template-based coding method is a method of identifying a template matching a pattern formed by data, that is, an object of coding, and coding data based on a relation between data, that is, an object of coding, and an identified template. In this case, when an object of template-based coding is one value, the one value can be represented by a plurality of data, that is, an object of template-based coding.

To help understanding, when one value is ‘10’, ‘10’ can be represented by a binary ‘1010’. At this time, a plurality of data refer to bits 1 0 1 0. The template refers to a bundle of data showing a constant pattern, and can be previously decided on the basis of patterns that appear frequently. That is, in the case of template-based coding, a plurality of templates can be previously set and prepared. Alternatively, a template can be calculated. For example, when an object of template-based coding is a plurality of values, a template can be previously set, and an object of template-based coding is a singular number, for example, one value, a template can be calculated.

A template has the same form as that grouping data in the data grouping part 100. That is, the shape of the template is the same as that of a data group. For example, when data are grouped in a vector form in the data grouping part 100, a template has a vector form. Further, when data are grouped in a matrix form, a template has a matrix form. In this case, the data grouping part 100 groups data and estimates a data group such that the length/size of the template are the same as the length/size of the data group.

In the case of template-based coding, a factor [or an index] for identifying a template having a pattern matching a pattern formed by a plurality of data, that is, an object of coding is found as the pattern information. Alternatively, a gain, that is, a size difference or a ratio between a plurality of data, that is, an object of template-based coding, and data belonging to a template is found as the pattern information. In relation to the issue, a difference value, which is obtained by subtracting the product of data belonging to a template corresponding to an index and a gain g from data, that is, an object of template-based coding, is found as the pattern residual information.

The gain can be controlled depending on the attribute of data (or values) belonging to the template. Incidentally, values belonging to the template may be the same or different from each other. If values belonging to the template are the same, the same values can be changed into smaller values by controlling the gain. To help understanding, in the case where values belonging to a template are [3 3 3 3 3], the values can be considered as 3*[1 1 1 1]. Thus, the template is changed from [3 3 3 3 3] to [1 1 1 1 1] and the amount of the gain increases three times. If it is generalized, in the case where the template is [fh fh fh fh fh], the template is changed into [h h h h h], and the gain is changed from ‘g’ into ‘g*f’.

As described above, in the case where values belonging to the template are the same, the template always has the same form (ex [h h h h h]) and only the gain g is changed. Accordingly, an index for the template is not transmitted to the decoding apparatus 2, but only the gain can be transmitted to the decoding apparatus 2. At this time, the pattern information has only the gain. Hereinafter, the operation of the data grouping part 100 for template-based coding is described assuming that the number of data [S(n)] included in a frame, that is, an object of template-based coding is N and the size of the template is M. Assuming that each component of an object group is V(m), it results in 1≦m≦M, 1≦n≦N.

The data grouping part 100 can group N data based on the above grouping method in various ways by binding the data every M in number. In other words, the data grouping part 100 functions to reconstruct the number N of data, that is, an object of interest according to the size M of a template.

First, in the case of N=M, that is, when the number of data included in a frame is identical to the size of the template, the data grouping part 100 does not perform an additional grouping operation. This is because template-based coding can be performed on N data itself, which is given from the outside on a frame basis.

Next, in the case of N=K*M, the data grouping part 100 groups the N data by binding them every M in number, and estimates an object group as many as K. Alternatively, the data grouping part 100 can group the N data every K in number using the interleave method, and generate K object groups. For example, when N=6 and K=3, S(0) S(1) can become an object group, S(2) S(3) can become another object group, and S(4) S(5) can become still another object group. Alternatively, in the case of interleaving, S(0) S(3) can become an object group, S(1) S(4) can become another object group, and S(2) S(5) can become still another object group. When M is smaller than N, and N and M have an integral multiple relationship as described above, a unit frame can be coded by template-based coding as many as K times.

An embodiment of template-based coding according to the present invention is described below.

First, a pattern formed by a plurality of data, that is, an object of coding is recognized. A template, which has a pattern matching a recognized pattern, is selected from a plurality of templates. An index identifying a selected template is decided as pattern information. At this time, a gain capable of minimizing pattern residual information is decided. In other words, a gain capable of minimizing a difference value, which is generated by multiplying data belonging to the template and the gain and subtracting the product result from data, that is, an object of template-based coding. A method of deciding the gain may include several methods. For example, the gain can be decided so that power values, distribution values, a weighted sum or a bit number necessary for coding of residual components included in pattern residual information can be minimized. Alternatively, the gain can be decided so that power values, distribution values, a weighted sum and a bit number necessary for coding of residual components can be minimized compositively.

Second, pattern residual information corresponding to the pattern information including the gain and/or the index is generated. As an embodiment, data belonging to a recognized template and a gain are first multiplied. The product result is subtracted from a plurality of data, that is, an object of template-based coding. The subtraction result is decided as pattern residual information. That is, the pattern residual information can be expressed in the following Math Figure 2.

R(m)=V(m)−g×T(j,m) MathFigure 2

where, R(m) is pattern residual information, V(m) is an object group, T(j,m) is a template pointed by an index j, m is an index of data belonging to a template where 1≦m≦M, and M is the length (or size) of a template.

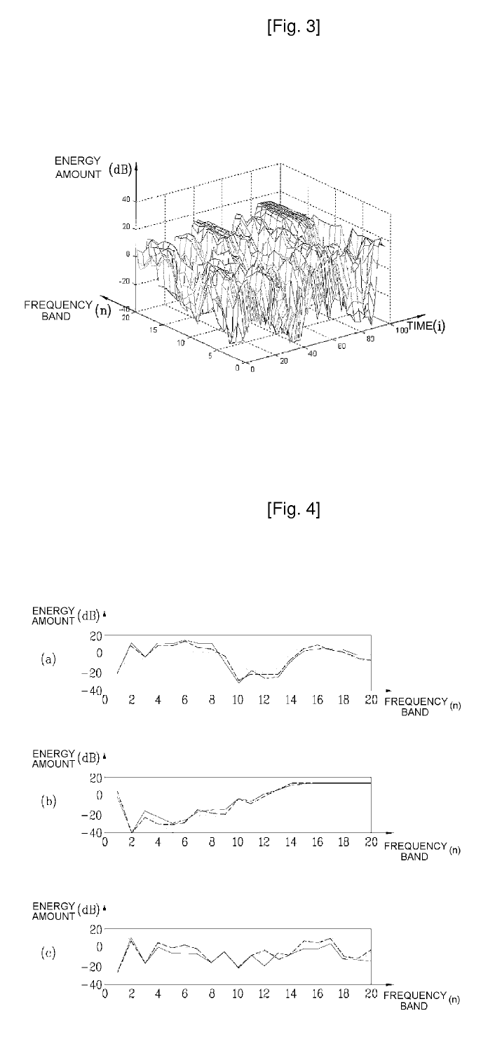

As another embodiment, a plurality of templates corresponding to data, that is, an object of template-based coding are selected. Data belonging to the plurality of selected templates and a gain are multiplied. The product results are added. The sum result is subtracted from the data, that is, an object of template-based coding. The subtraction result is decided as pattern residual information. Residual information can be expressed in the following Math Figure 3.

RX(m)=V(m)−(g1×T1(j1,m)+g2×T2(j2,m)+ . . . +gX×TX(jX,m)) MathFigure 3

where, RX(m) is pattern residual information, V(m) is an object group, g1 to gX are gains, and T1(j1,m) to TX(jX,m) are templates pointed by indices j1 to jX. The template [Tx(jx,m)] is prepared as many as Jx where 1≦x≦X. In Math Figure 3, the gains g1 to gX and the indices j1 to jX are transmitted as pattern information.

Third, according to the present invention, at least one of the pattern information and the pattern residual information can be coded. At this time, at least one of the pattern information and the pattern residual information can be coded using either lossless coding or loss coding based on a data transmission rate in its transmission process. For example, in the case where the data transmission rate is sufficient and lossless coding is performed on all of pattern residual information, a lossless coding method, such as the entropy coding method, can be employed.

Further, in the case where the data transmission rate is short, lossless coding can be performed on some of the pattern residual information and loss coding can be performed on the remaining pattern residual information. Alternatively, lossless coding can be performed on some of the pattern residual information, and the remaining pattern residual information can be transmitted or not transmitted without being coded, depending on the data transmission rate. In the case where the pattern residual information is coded in the data encoder 200 shown in FIG. 1 as described above, the pattern residual information is decoded in the data decoder 800 shown in FIG. 2. If the pattern residual information experiences lossless coding/decoding, an original signal can be completely restored by means of template-based coding. It is evident that the pattern information can also be coded in the same manner as the pattern residual information.

As described above, the process of decoding a template-based coded data is a reverse order of the coding process. In more detail, a template pointed by an index, that is, pattern information is selected from a plurality of templates. An object group is acquired based on the selected template, a gain and pattern residual information. In more detail, in the case where pattern residual information is generated as in Math Figure 2, data belonging to a selected template and a gain can be multiplied. The product result can be added to residual components belonging to pattern residual information in order to obtain an object group [V′(m)]. This can be expressed in the following Math Figure 4.

V′(m)=R(m)+g×T(j,m) MathFigure 4

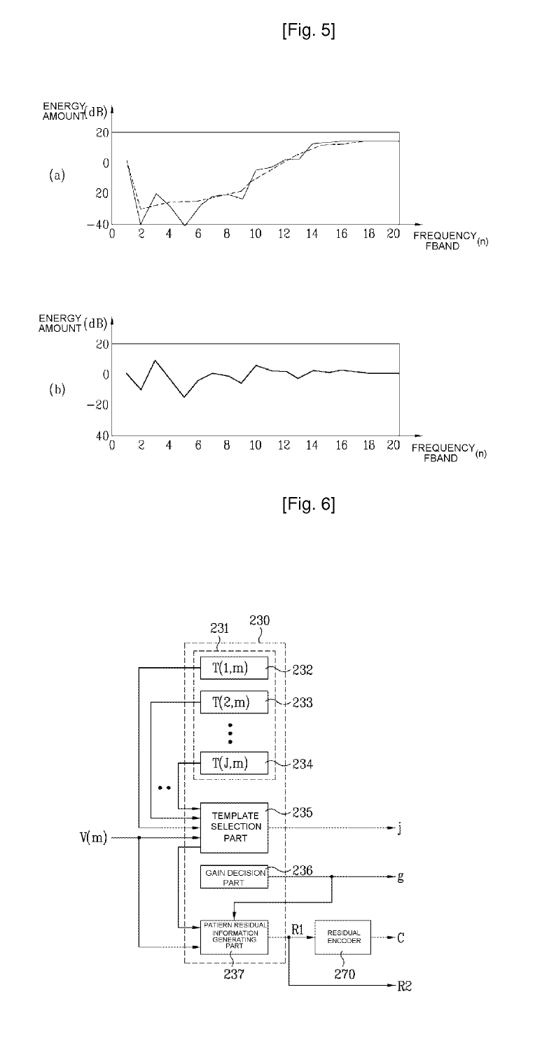

Alternatively, in the case where pattern residual information is generated as in Math Figure 3, templates pointed by a plurality of indices and a plurality of gains can be multiplied. The multiplied results can be added. The sum result and the pattern residual information can be added to obtain an object group. This can be expressed in the following Math Figure 5.

V′(m)=RX(m)+(g1×T1(j1,m)+g2×T2(j2,m)+ . . . +gX×TX(jX,m)) MathFigure 5

If the object group is acquired as described above, a plurality of original data are restored from the object group.

In order to help the understanding of template-based coding, it is hereinafter assumed that a plurality of data, that is, an object of template-based coding include 7, 6, 2, 8, 9, 10, 11, 16, 5, 4 . . . as in the above-mentioned example.

In the case where patterns of [7 6 2 8 9] or [10 11 16 5 4] frequently appear in data, that is, an object of template-based coding, the data grouping part 100 groups the data in a one-dimensional matrix, that is, a 1×a or a×1 matrix. The data grouping part 100 can group the data by employing Math Figure 1 and a two or more-dimensional matrix.

It is hereinafter assumed that data, that is, an object of coding is “object data”, and data belonging to a template is “template data”.

In order to help the understanding of the present invention, the object data can be grouped in a one-dimensional matrix, for example, in the form of [7 6 2 8 9] or [10 11 16 5 4], a first (j=0) data group is matched to a template data having the pattern [7 5 1 8 9], a second (j=1) data group is matched to a template data having the pattern [5 5 8 2 2], and pattern residual information can be found by the above Math Figure 2.

First, in the case of V(m)=[7 6 2 8 9], g is decided as “1” and j is decided as “0”, so that the pattern residual information becomes [0 1 1 1 0 0]. At this time, the gain g is decided as “1”, which is a value to decrease a power value, a distribution value, a weighted sum w or a bit number necessary for coding by residual components [r1 r2 r3 r4 r5] (r1=0, r2=1, r3=1, r4=0, r5=0) included in the pattern residual information. In this case, the weighted sum refers to the sum of adding the products results in which the components r1 r2 r3 r4 r5 are multiplied by weights w1 w2 w3 w4 w5, respectively. At this time, the panel information g=1 and j=0 and the pattern residual information [0 1 1 0 0] are output from the data encoder 200.

Next, in the case of V(m)=[10 11 16 5 4], g is decided as “2” and j is decided as “1”, so that the pattern residual information becomes [0 1 0 1 0].

The pattern information may have the same values included in the matrix. In this case, the pattern information can be expressed as one value included in the matrix. For example, when the pattern information is [3 3 3 3 3], it can be expressed by reducing it to 3. At this time, the pattern information has the form of [1 1 1 1 1] and may have only a varying gain.

A case where template-based coding is applied to the processing of an audio signal is described below as an example. It is first assumed that data, that is, an object of template-based coding is frequency band-based energy of an audio signal.

FIGS. 3 to 5 are exemplary views for helping the understanding of template-based coding. FIG. 3 is a view illustrating the relationship between the frequency band, time and energy amount. FIGS. 4(a) to 4(c) are graphs showing a variety of patterns as the relationship between the energy amount and the frequency band in each of pre-determined time slots. FIGS. 5(a) and 5(b) are views illustrating the relationship between the energy amount and the frequency band in order to describe the efficiency of template-based coding.

Referring to FIG. 3, an audio signal experiences frequency conversion on a constant-period basis at a time axis i. Such frequency conversion can be performed by the filter bank. Assuming that the sample number of converted frequency spectra is Y, Y is reconstructed as a signal having N (N=20 in FIG. 3) bands N<Y, an energy value in each band is represented as dB scales, and a fixed number value can be defined as S(n). That is, data, that is, an object of template-based coding becomes S(0) to S(19).

If S(n) is graphed in given time slots shown in FIG. 3, different kinds of patterns can be seen as illustrated in FIGS. 4(a) to 4(c). Accordingly, it can be seen that the patterns have less distribution, and template-based coding can be effectively applied to a plurality of object data [S(n)] forming a pattern matching the template data pattern.

In FIG. 5(a), a solid line indicates a plurality of object data [S(n)] in a specific time slot. For convenience of description, it is assumed that the number of template data is the same as the number of object data. A dotted line shown in FIG. 5(a) indicates the product result [g*T] of a template data having a pattern that is matched to the pattern of the solid line and a gain. Therefore, pattern residual information, that is, a difference between the solid line and the dotted line shown in FIG. 5(a) can be found as illustrated in FIG. 5(b). Distribution of a plurality of object data corresponding to the solid line shown in FIG. 5(a) is 377.6, whereas distribution of the pattern residual information shown in FIG. 5(b) is 25.1. The pattern residual information having less distribution, as shown in FIG. 5(b), is advantageous in terms of compression compared with an original object data.

FIG. 6 is a block diagram of the first or second data encoding part 210 or 220 for compressing a signal based on template-based coding according to an embodiment of the present invention. The first or second data encoding part 210 or 220 includes a template compression part 230 and a residual encoder 270. In this case, the data encoding part 210 or 220 shown in FIG. 6 may not include the residual encoder 270.

The template compression part 230 shown in FIG. 6 functions to generate pattern information and pattern residual information from the object group [V(m)] grouped in the data grouping part 100. To this end, the template compression part 230 includes a template storage part 231, a template selection part 235, a gain decision part 236 and a pattern residual information generating part 237.

The template storage part 231 stores a plurality of different templates 232, 233, . . . and 234. At this time, the template selection part 235 selects a template having a pattern, which is matched to a pattern of object data belonging to the object group [V(m)], from the templates 232, 233, . . . and 234, and outputs an index J of a selected template as the pattern information.

In this case, the gain decision part 236 decides a gain as described above, and outputs the decided gain to the pattern residual information generating part 237 as the pattern information. The pattern residual information generating part 237 generates pattern residual information based on the gain g, the template [T(j,m)] pointed by the decided index j, and the object group [V(m)] in accordance with Math Figure 2 or 3, and outputs the generated pattern residual information to the residual encoder 270. The residual encoder 270 encodes the pattern residual information generated from the pattern residual information generating part 237, and outputs an encoded result C. At this time, the residual encoder 270 can encode the pattern residual information by using any one of data coding and entropy coding. In this case, the encoded result C can be the result of encoding all the pattern residual information, but may be the result of encoding some R1 of the pattern residual information. At this time, the remnant R2 of the pattern residual information that has not been encoded can be transmitted without change, as illustrated in FIG. 6, or cannot be transmitted.

In the case where template-based coding is applied to the second data encoding part 220, the pattern information g and/or j and/or the pattern residual information R can be output to the entropy encoding part 300 or can be directly output to the bitstream multiplexing part 400. However, in the case where template-based coding is applied to the first data encoding part 210, the pattern information and/or the pattern residual information can be output to the second data encoding part 220 for data coding again. Alternatively, the pattern information and/or the pattern residual information can be output to the entropy encoding part 300 for entropy encoding. Alternatively, the pattern information and/or the pattern residual information can be output to the bitstream multiplexing part 400.

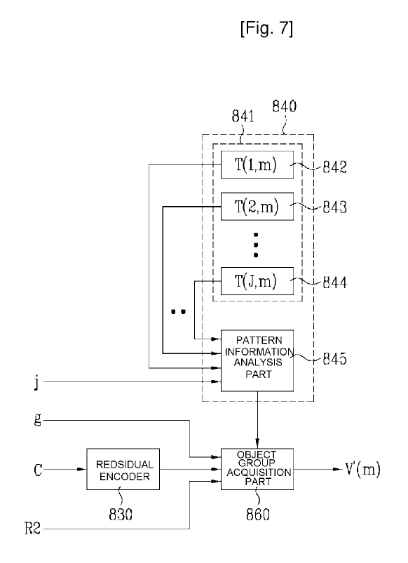

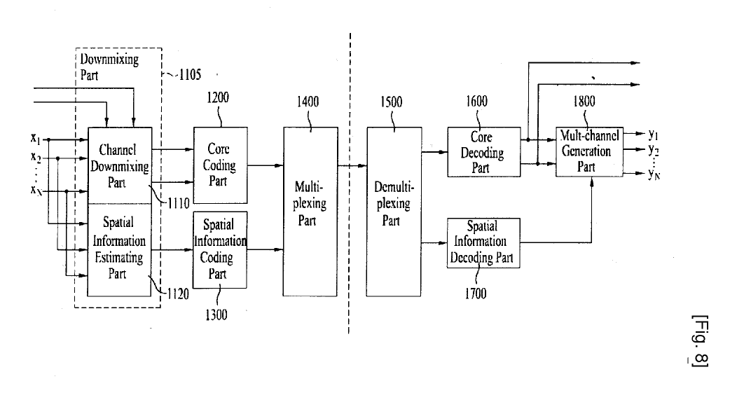

FIG. 7 is a block diagram of the first or second decoding part 810 or 820 for restoring a compressed signal based on template-based coding according to an embodiment of the present invention. The first or second decoding part 810 or 820 includes a residual decoder 830, a template restoration part 840, and an object group acquisition part 860. In the case where the first or second data encoding part 210 or 220 shown in FIG. 1 does not include the residual encoder 270, the first or second data decoding part 810 or 820 shown in FIG. 2 does not include the residual decoder 830.

The template restoration part 840 shown in FIG. 7 restores a template by using pattern information and pattern residual information. To this end, the template restoration part 840 can be implemented using a template storage part 841 and a pattern information analysis part 845. The template storage part 841 is the same as the template storage part 231 shown in FIG. 6. The residual decoder 830 is provided when the pattern residual information is encoded as illustrated in FIG. 6, and decodes encoded pattern residual information according to any one of a codec method and an entropy method. If the information transmission rate is lower than the amount of pattern residual information to be encoded in the residual encoder 270, the residual encoder 270 can reduce and code the pattern residual information, and the residual decoder 830 can decode and scale the pattern residual information. For example, in the case where the pattern residual information is interleaved and reduced in the residual encoder 270, the residual decoder 830 can scale the size of the pattern residual information through interpolation.

The pattern information analysis part 845 analyzes an index, that is, the pattern information generated in and sent from the encoding apparatus 1 shown in FIG. 1, selects a corresponding template pointed by the index, and outputs the selected template to the object group acquisition part 860. The object group acquisition part 860 restores an object group [V′(m)] based on the selected template, the gain and the decoded pattern residual information in accordance with, for example, Math Figure 4 or 5. In relation to the issue, when all of the pattern residual information is encoded (C) and transmitted, the object group acquisition part 860 acquires the object group based on the pattern residual information decoded in the residual decoder 830, the gain, and the template. However, when some (R1) of the pattern residual information is encoded and transmitted, the object group acquisition part 860 can acquire the remainder R2 of the pattern residual information from the outside in addition to the pattern residual information decoded in the residual decoder 830 in order to acquire the object group.

In the case where template-based coding is applied to the second data decoding part 820, the data restoring part 900 restores an original data from the acquired object group. However, in the case where template-based coding is applied to the first data decoding part 810, data belonging to the acquired object group can be output to the second data decoding part 820 and can be decoded again. Alternatively, the acquired object group can be directly output to the data restoring part 900 instead of being output to the second data decoding part 820, and can be then restored in the form of data. In other words, an operation corresponding to the encoding apparatus 1 shown in FIG. 1 can be performed.

An example in which the signal processing method and apparatus according to the present invention are applied to audio coding is described below with reference to the accompanying drawing.

FIG. 8 is a block diagram of the signal processing apparatus for audio compression and restoration according to an embodiment of the present invention. The signal processing apparatus includes audio compression parts 1105 to 1400, and audio restoration parts 1500 to 1800.

The audio compression parts 1105 to 1400 include a down-mixing part 1105, a core coding part 1200, a spatial information coding part 1300, and a multiplexing part 1400. The down-mixing part 1105 includes a channel down-mixing part 1110 and a spatial information extracting part 1120.

In the down-mixing part 1105, inputs to the channel down-mixing part 1110 include audio signals of N multi-channels X1, X2, . . . , XN or external down-mix signals that are arbitrarily generated. The channel down-mixing part 1110 outputs down-mixed signals through channels having a number smaller than the channel number of the inputs by using a predetermined down-mixing method. The outputs of the down-mixing part 1105 can be down-mixed as one or two channels, can be down-mixed as a specific number of channels according to an additional down-mixing command, or can be down-mixed as a specific number of channels that is previously set in terms of system implementation.

The core coding part 1200 performs core coding on the output of the channel down-mixing part 1110, that is, the down-mixed audio signal. In this core coding, the inputs can be compressed by a variety of transform methods, such as a discrete transform method. Alternatively, the core coding can be carried out by pattern-based coding according to the present invention.

The spatial information extracting part 1120 extracts spatial information from an audio signal of a multi-channel, and sends the extracted spatial information to the spatial information coding part 1300. The spatial information coding part 1300 performs data coding and entropy coding on the received spatial information. The spatial information coding part 1300 can perform the pattern-based coding through data coding, and may further perform entropy coding, if appropriate. A decoding method in the spatial information decoding part 1700 can be determined depending on which data coding method has been used in the spatial information coding part 1300.

The output of the core coding part 1200 and the output of the spatial information coding part 1300 are input to the multiplexing part 1400. The multiplexing part 1400 transmits a multiplexed bitstream of the two inputs to the audio restoration parts 1500 to 1800.

The audio restoration parts 1500 to 1800 include a demultiplexing part 1500, a core decoding part 1600, a spatial information decoding part 1700, and a multi-channel generating part 1800.

The demultiplexing part 1500 demultiplexes the received bitstream into an audio part and a spatial information part. The audio part is a compressed audio signal, and the spatial information part is compressed spatial information.

The core decoding part 1600 receives the compressed audio signal from the demultiplexing part 1500. The core decoding part 1600 decodes the compressed audio signal and generates a down-mixed audio signal. The spatial information decoding part 1700 receives the compressed spatial information from the demultiplexing part 1500. The spatial information decoding part 1700 decodes the compressed spatial information and generates spatial information.

To this end, identification information indicating coding information is extracted from the bitstream, and a specific one of one or more decoding methods is selected according to the identification information. The audio signal and/or spatial information are/is decoded using the selected decoding method, generating spatial information. In this case, the decoding method of the core decoding part 1600 can be determined depending on which coding method has been used in the core coding part 1200. If the audio signal has been compressed in the core coding part 1200 based on pattern-based coding according to the present invention, the core decoding part 1600 decodes the compressed audio signal based on pattern-based coding according to the present invention. Furthermore, the decoding method in the spatial information decoding part 1700 can be determined depending on which data coding method has been used in the spatial information coding part 1300. If spatial information has been compressed in the spatial information coding part 1300 based on pattern-based coding according to the present invention, the spatial information decoding part 1700 codes the compressed spatial information based on pattern-based coding according to the present invention.

The multi-channel generating part 1800 receives the output of the core decoding part 1600, and also receives the output of the spatial information decoding part 1700. The multi-channel generating part 1800 generates audio signals of N multi-channels y1, y2, . . . , yN based on the two outputs.

Meanwhile, the audio compression parts 1100 to 1400 provide identification information, indicating which data coding method is used in the spatial information coding part 1300, to the audio restoration parts 1500 to 1800. In preparation for the above case, the audio restoration parts 1500 to 1800 include means for parsing the identification information. Accordingly, the spatial information decoding part 1700 decides a decoding method with reference to the identification information received from the audio compression parts 1105 to 1400. Preferably, the means for parsing the identification information indicating the coding method is provided in the spatial information decoding part 1700.

### INDUSTRIAL APPLICABILITY

The preferred embodiments are merely exemplary, and many alternatives, modifications, and variations of other various embodiments will be apparent to those skilled in the art within the technical spirit of the present invention disclosed in claims and a technical range thereof. For example, a variety of application fields and products to which grouping, data coding, and entropy coding according to the present invention are applied are possible. Furthermore, a medium for storing data to which at least one aspect of the present invention is applied can be provided.

1. A signal processing method, comprising the steps of:
acquiring pattern information corresponding to a pattern formed by a plurality of data, and pattern residual information generated in response to the pattern information; and
acquiring the data based on the pattern information and the pattern residual information.

2. The signal processing method of claim 1, wherein at least one of the pattern information and the pattern residual information is generated with respect to an object group when the plurality of data are grouped.

3. The signal processing method of claim 2, wherein the plurality of data are grouped into the object group according to at least one of an interleave method, a vector method, and a matrix method.

4. The signal processing method of claim 3, wherein when the plurality of data are grouped by the vector method, a length of the vector is decided regularly or irregularly.

5. The signal processing method of claim 3, wherein when the plurality of data are grouped by the matrix method, a size of the matrix is decided regularly or irregularly.

6. The signal processing method of claim 1, wherein the pattern information comprises at least one of an index indicating a template that is matched to a pattern of the plurality of data, and a gain between the object data and the template data.

7. The signal processing method of claim 6, wherein the pattern residual information is generated by subtracting the product of the template data, belonging to a template pointed by the index, and the gain from the object data.

8. The signal processing method of claim 7, wherein the gain is decided as a value to minimize the subtraction result.

9. The signal processing method of claim 7, wherein the gain is decided as a value to minimize a power value, a distribution value, a weighted sum or a bit number necessary for coding, of residual components included in the pattern residual information, or a value to compositively minimize a power value, a distribution value, a weighted sum, and a bit number necessary for coding, of residual components included in the pattern residual information.

10. The signal processing method of claim 6, wherein the step of acquiring the data comprises the steps of:
selecting a template pointed by the index from a plurality of templates; and
restoring the object data by using at least one of the selected template, the gain and the pattern residual information.

11. The signal processing method of claim 10, wherein the step of restoring the object data comprises the steps of:
multiplying a template data belonging to the selected template by the gain; and
adding the product result to residual component belonging to the pattern residual information.

12. The signal processing method of claim 10, wherein the step of restoring the object data comprises the steps of:
multiplying templates pointed by a plurality of indices by a plurality of gains;
summing the product results; and
summing the sum result and the pattern residual information.

13. The signal processing method of claim 1, further comprising the step of decoding at least one of the pattern information and the pattern residual information.

14. The signal processing method of claim 1, further comprising the step of decoding the pattern residual information using at least one of a data codec method and an entropy codec method.

15. The signal processing method of claim 1, further comprising the step of decoding the acquired data using a data codec method.

16. The signal processing method of claim 1, further comprising the step of restoring an audio signal by using the acquired data as a parameter.

17. The signal processing method of claim 16, wherein the data is one of a quantized sample of the audio signal, a quantized parameter of the audio signal, an index of the parameter, and error samples before the audio signal is quantized.

18. A signal processing method, comprising the steps of:
generating pattern information corresponding to a pattern formed by a plurality of data, and pattern residual information corresponding to the pattern information; and
outputting the pattern information and the pattern residual information.

19. The signal processing method of claim 18, further comprising the step of grouping the plurality of data to generate an object group.

20. The signal processing method of claim 18, wherein the step of generating the pattern information and the pattern residual information comprises the steps of:
selecting a template having data having a pattern that is matched to the pattern formed by the data; and
generating the pattern residual information by using at least one of the selected template and a gain,
wherein at least one of an index indicating the template and the gain corresponds to the pattern information.

21. The signal processing method of claim 20, wherein the step of generating the pattern residual information comprises the steps of:
multiplying data belonging to the selected template by the gain; and
subtracting the product result from data that is an object of coding.

22. The signal processing method of claim 20, wherein the step of generating the pattern residual information comprises the steps of:
multiplying a plurality of the selected templates and a plurality of the gains;
summing the product results; and
subtracting the sum result from data that is an object of coding.

23. The signal processing method of claim 18, further comprising the step of encoding at least one of the pattern information and the pattern residual information.

24. A signal processing apparatus, comprising:
an information acquisition part for acquiring pattern information corresponding to a pattern formed by a plurality of data, and pattern residual information generated in response to the pattern information; and
a data acquisition part for acquiring the data based on the pattern information and the pattern residual information.

25. The signal processing apparatus of claim 24, further comprising a residual decoder for decoding the pattern residual information.

26. A signal processing apparatus, comprising:
an information generating part for generating pattern information corresponding to a pattern formed by a plurality of data, and pattern residual information corresponding to the pattern information; and
an information output part for outputting the pattern information and the pattern residual information.

27. The signal processing apparatus of claim 26, further comprising a residual encoder for encoding the pattern residual information.

28. A signal processing method, comprising the steps of:
acquiring identification information indicating a data coding method, pattern information corresponding to a pattern formed by a plurality of data, and pattern residual information corresponding to the pattern information; and
acquiring the data based on the pattern information and the pattern residual information in accordance with the data coding method based on the identification information.

29. The signal processing method of claim 28, wherein the data coding method is decided according to the pattern formed by the plurality of data that is an object of coding.

30. The signal processing method of claim 29, wherein the data coding method includes a template-based method.

31. A signal processing apparatus, comprising:
an information acquisition part for acquiring identification information indicating a data coding method, pattern information corresponding to a pattern formed by a plurality of data, and pattern residual information corresponding to the pattern information; and
a data acquisition part for acquiring the data based on the pattern information and the pattern residual information in accordance with the data coding method based on the identification information.

32. A signal processing method, comprising the steps of:
generating identification information indicating a data coding method decided according to a predetermined condition, pattern information corresponding to a pattern formed by a plurality of data, and pattern residual information corresponding to the pattern information; and
outputting the identification information, the pattern information, and the pattern residual information.

33. The signal processing method of claim 32, wherein the predetermined condition includes the pattern formed by the plurality of data.

34. A signal processing apparatus, comprising:
an information generating part for generating identification information indicating a data coding method decided according to a predetermined condition, pattern information corresponding to a pattern formed by a plurality of data, and pattern residual information corresponding to the pattern information; and
an information output part for outputting the identification information, the pattern information, and the pattern residual information.
